(19) United States
(12) Patent Application Publication
(10) Pub. No.: US 2008/0205619 A1
(43) Pub. Date: Aug. 28, 2008

(54) CALLER INITIATED COMMUNICATIONS INTERRUPTION

(75) Inventors: Chris T. Kalaboukis, Los Gatos, CA (US); F. Randall Farmer, Palo Alto, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/677,977

(22) Filed: Feb. 22, 2007

(51) Int. Cl. H04M 3/428

(52) U.S. Cl. 379/215.01

(57) ABSTRACT

Enabling a caller to automatically interrupt a currently active call. In one embodiment, a call manager receives a request from an interrupter that may indicate an urgency, an identification, an authorization, and/or other reason to interrupt the current call between a target party device and a bystander party device. Warning messages can be provide to the target and/or bystander party. The call manager may automatically connect the call or determine whether to connect the interrupter based on one or more criteria predefined by the target and/or the interrupter. Alternatively, the target may make the determination based on information about the requested interruption. The bystander party device may be placed on hold, or a conference call may be initiated automatically. Call management may be performed directly, or through one or more network carriers. A rejected interruption may be routed to voice mail. After completing the interruption, the original call is reestablished.

### FIELD OF ART

The present invention is directed to interrupting a communication, and more specifically to enabling a caller to interrupt an existing voice communication.

### BACKGROUND

In conventional public switch telephone networks (PSTN), a caller can contact an operator and request that an operator interrupt an existing telephone call for an emergency. Typically, the caller identifies himself or herself, and explains the emergency to the operator. The operator can then interrupt the existing call and explain that an emergency interruption is desired by the interrupter. The target of the interruption generally informs the operator whether the interruption will be accepted. Many PSTN systems use fewer and fewer human operators. Instead, these systems rely more and more on automated call-waiting and/or caller-id systems. These systems enable a call recipient to decide whether to take another call. However, a caller generally can not indicate an emergency to a call-waiting system or to a caller-id system. There are also conference call systems in which a caller can connect to an existing call. But this generally does not interrupt existing communication by putting existing participants on hold, rerouting the existing participants, or terminating communications with the existing participants.

Voice calls are also possible through the internet and intranets, such as in a voice over internet protocol (VOIP) environment. Such networks generally do not have operators available to assist with emergencies. VOIP systems also often have call-waiting and/or caller-id capabilities that enable a call recipient to decide whether to take another call. Similar to the PSTN systems, VOIP call-waiting and caller-id generally do not enable the caller to indicate an emergency. VOIP conference call systems also generally do not interrupt existing communications to enable another party to join the conference call. It is with regard to these and other issues that the invention is directed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram of an example server and computing environment according to one embodiment of the invention;

FIG. 2 shows a functional block diagram of an example mobile device according to one embodiment of the invention; and

FIG. 3 is a flow diagram illustrating example logic for interrupting a currently active call.

### DETAILED DESCRIPTION OF THE INVENTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.” The term “or” is an inclusive “or” operator, and includes the term “and/or,” unless the context clearly dictates otherwise. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise. The term “user” can include a computer user, a mobile device user, an online service subscriber, and/or other person using an electronic device. The term “message” can include a copy of a message.

Briefly stated, the invention is direct to a method and system for enabling a caller to interrupt an existing call without the assistance of an operator, and for enabling a recipient to control such interruptions. An interruption may result in a pause in a currently active call, a termination of a currently active call, a joining of a currently active call, or the like.

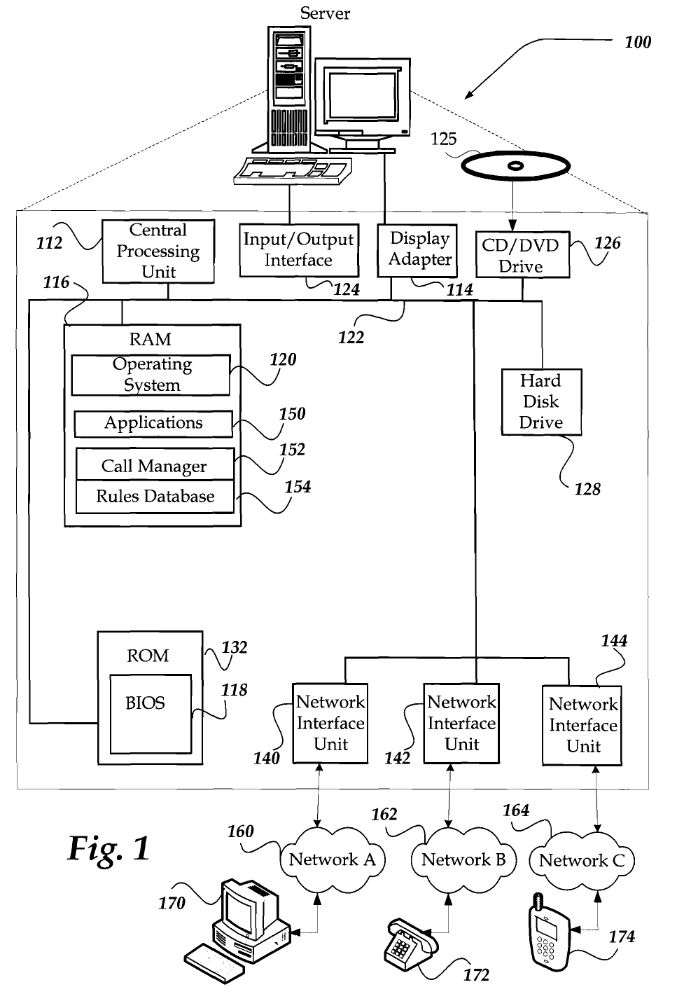

FIG. 1 shows a functional block diagram of an example server 100, according to one embodiment of the invention. Server 100 may include many more components than those shown. The components shown, however, are sufficient to disclose an illustrative embodiment for practicing the invention. Client devices can be similarly configured. Client devices can include, but are not limited to, other servers, personal computers (PCs), PDAs, mobile devices (e.g., cell phones), voice mail systems, and the like. Server 100 includes a processing unit 112, a video display adapter 114 that can drive a display, and a mass memory, all in communication with each other via a bus 122. The mass memory generally includes RAM 116, ROM 132, and one or more permanent mass storage devices, such as an optical drive 126 that can read a machine readable medium such as a CD 125, a hard disk drive 128, a tape drive, a floppy disk drive, and/or the like. The mass memory stores an operating system 120 for controlling the operation of server 100. Any general-purpose operating system may be employed. A basic input/output system (“BIOS”) 118 is also provided for controlling low-level operation of server 100.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, wired or wireless transmission media, or any other medium which can be used to store or transmit the desired information and which can be accessed by a computing device.

The mass memory also stores program code and data. One or more applications 150 are loaded into mass memory and run on operating system 120. Examples of application programs include browsers, database programs, schedulers, transcoders, calendars, web services, word processing programs, spreadsheet programs, email programs, and so forth. Mass storage may further include applications such as a call manager 152 for managing communication to and from clients. A rules database 154 may also be included with call manager 152 or may separate, but in communication with the call manager. The rules database includes rules and/or other criteria for determining whether an interruption should be allowed.

Server 100 also includes input/output interface 124 for communicating with external devices, such as a mouse, keyboard, scanner, or other input device. Server 100 can communicate with a local network, the Internet, a telephone network, and/ or some other communications network via network interface units 140-144, which are constructed for use with one or more various communication protocols including transmission control protocol/Internet protocol (TCP/IP), user datagram protocol (UDP), H.323, session initiation protocol (SIP), code division multiple access (CDMA), time division multiple access (TDMA), global system for mobile communications (GSM), Institute for Electrical and Electronics Engineers (IEEE) 802.11, IEEE 802.16 (WiMax), short message service (SMS), general packet radio service (GPRS), Wireless Application Protocol (WAP), and the like. Network interface units 140-144 are sometimes known as transceivers, transceiving devices, network interface cards (NICs), and the like. The network interface units can facilitate communications between computing devices that conform to the same or differing communication protocols. For example, network interface units 140-144 are illustrated as communicating with networks 160-164, which may comprise the Internet, a PSTN, cellular telephone carrier networks, and/or other networks. Networks 160-164 provide communication services for clients such as clients 170-174. Clients may include general purpose or specialized computing devices. The computing devices generally include communication components, such as a microphone and speaker. The clients may also include dedicated communication apparatus, such as a plain old telephone (POTS) apparatus, a cordless telephone, and the like.

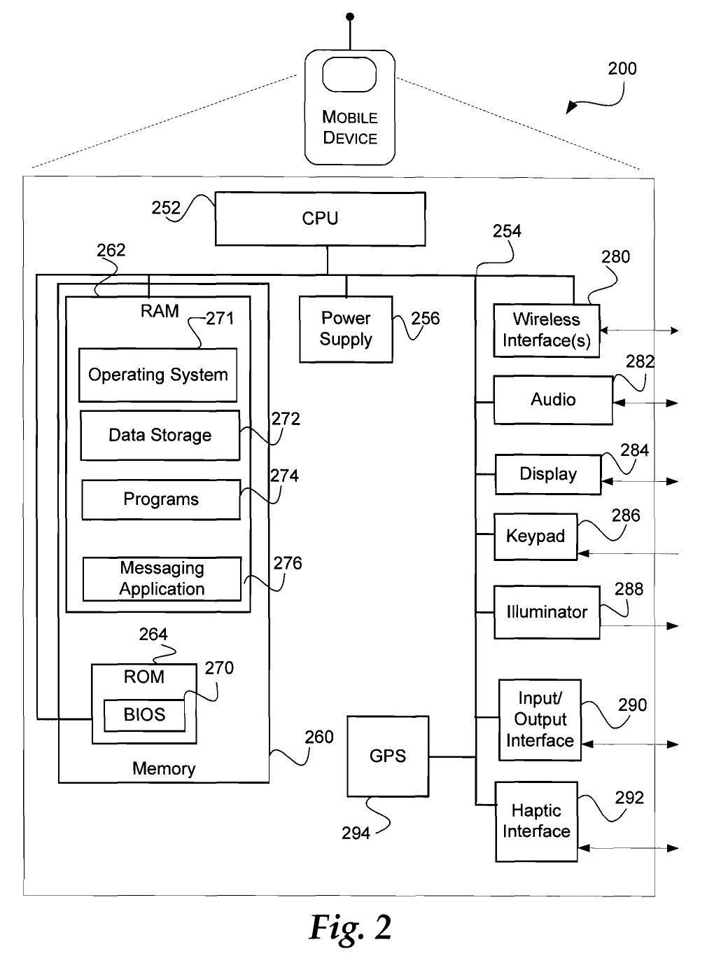

FIG. 2 shows an example client device in the form of a mobile device 200, according to one embodiment of the invention. In one embodiment, mobile device 200 is a cellular telephone that is arranged to send and receive voice communications and data messages such as SMS messages via one or more wireless communication interfaces. Generally, mobile device 200 may comprise any personally mobile electronic device. Oftentimes, mobile electronic devices will be capable of personal communication by connecting to one or more wireless networks, connecting to multiple nodes of a single wireless network, communicating over one or more channels to one or more networks, or otherwise engaging in one or more communication sessions. Such devices include cellular telephones, smart phones, pagers, radio frequency (RF) devices, infrared (IR) devices, integrated devices combining one or more of the preceding devices, and the like. Mobile device 200 may also comprise other electronic devices such as Personal Digital Assistants (PDAs), handheld computers, personal computers, multiprocessor systems, microprocessor-based or programmable consumer electronics, network PCs, wearable computers, and the like.

Mobile device 200 may include many more components than those shown in FIG. 2. However, the components shown are sufficient to disclose an illustrative embodiment for practicing the present invention. As shown in the figure, mobile device 200 includes a processing unit 252 in communication with a mass memory 260 via a bus 254.

Mass memory 260 includes a RAM 262, a ROM 264, and other storage means. Mass memory 260 illustrates another example of computer storage media for storage of information such as computer readable instructions, data structures, program modules or other data. Mass memory 260 stores a basic input/output system (“BIOS”) 270 for controlling low-level operation of mobile device 200. The mass memory also stores an operating system 271 for controlling the operation of mobile device 200. It will be appreciated that this component may include a specialized mobile communication operating system such as Windows Mobile™, or the Symbian® operating system, or a general purpose operating system such as a version of UNIX, or LINUX™. The operating system may include, or interface with a virtual machine module, such as a Java virtual machine module, that enables control of hardware components and/or operating system operations via application programs, such as Java application programs and the like.

Memory 260 further includes one or more data storage units 272, which can be utilized by mobile device 200 to store, among other things, programs 274 and/or other data. Programs 274 may include computer executable instructions which, when executed by processor 252 and/or other components of mobile device 200, transmit, receive, and/or otherwise process data such as text, audio, video, web pages and/or other data. Other examples of application programs include browsers, calendars, contact managers, task managers, transcoders, database programs, word processing programs, spreadsheet programs, games, and so forth. In addition, mass memory 260 stores a client messaging application 276. Client messaging application 276 may include computer executable instructions, which may be run under control of operating system 271 to enable telecommunication with another mobile or non-mobile device and/or manage SMS, MMS, IM, email, and/or other messaging services for mobile device 200. Client messaging application 276 may also enable a user of mobile device 200 to set parameters or otherwise manage communication preferences and/or capabilities. Such preferences and/or capabilities may be controlled by the mobile device itself, and/or through communication with a remote device, such as a server.

Mobile device 200 also includes a power supply 256, one or more wireless interfaces 280, an audio interface 282, a display 284, a keypad 286, an illuminator 288, an input/output interface 290, a haptic interface 292, and an optional global positioning systems (GPS) receiver 294. Power supply 256 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another mobile device. In one embodiment, wireless interface 280 includes circuitry for coupling mobile device 200 to one or more wireless networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), Wireless Application Protocol (WAP), ultra wide band (UWB), IEEE 802.16 Worldwide Interoperability for Microwave Access (WiMax), and the like.

Audio interface 282 is arranged to produce and receive audio signals such as the sound of a human voice. For example, audio interface 282 may comprise or be coupled to a speaker and microphone (not shown) to enable telecommunication with others and/or to generate an audio acknowledgement for some action. Display 284 may be a liquid crystal display (LCD), gas plasma, light emitting diode (LED), or any other type of display used with a mobile device. Display 284 may also include a touch sensitive screen arranged to receive input from an object such as a stylus or a digit from a human hand.

Keypad 286 may comprise any input device arranged to receive input from a user. For example, keypad 286 may include a push button numeric dial, or a keyboard. Keypad 286 may also include command buttons that are associated with capturing, selecting, and/or sending images and/or other data. Illuminator 288 may provide a status indication and/or provide light. Illuminator 288 may remain active for specific periods of time or in response to events. For example, when illuminator 288 is active, it may backlight the buttons on keypad 286 and stay on while the mobile device is powered. Also, illuminator 288 may backlight these buttons in various patterns when particular actions are performed, such as dialing another mobile device. Illuminator 288 may also cause light sources positioned within a transparent or translucent case of the mobile device to illuminate in response to actions. Illuminator 288 may further provide a flash and/or other light for imaging, emergency signaling, and the like.

Mobile device 200 also comprises input/output interface 290 for communicating with external devices, such as a headset, or other input or output devices not shown in FIG. 2. Input/output interface 290 can utilize one or more communication technologies, such as USB, infrared, Bluetooth™, RF, and the like. Haptic interface 292 is arranged to provide tactile feedback to a user of the mobile device. For example, the haptic interface may be employed to vibrate mobile device 200 in a particular way when another user of a mobile device is calling.

Optional GPS transceiver 294 can determine the physical coordinates of mobile device 200 on the surface of the Earth, which typically outputs a location as latitude and longitude values. GPS transceiver 294 can also employ other geo-positioning mechanisms, including, but not limited to, triangulation, assisted GPS (AGPS), Enhanced Observed Time Difference (E-OTD), cell identifier (CI), service area identifier (SAI), enhanced timing advance (ETA), base station subsystem (BSS), and the like, to further determine the physical location of mobile device 200 on the surface of the Earth. It is understood that under different conditions, GPS transceiver 294 can determine a physical location within millimeters for mobile device 200; and in other cases, the determined physical location may be less precise, such as within a meter or significantly greater distances.

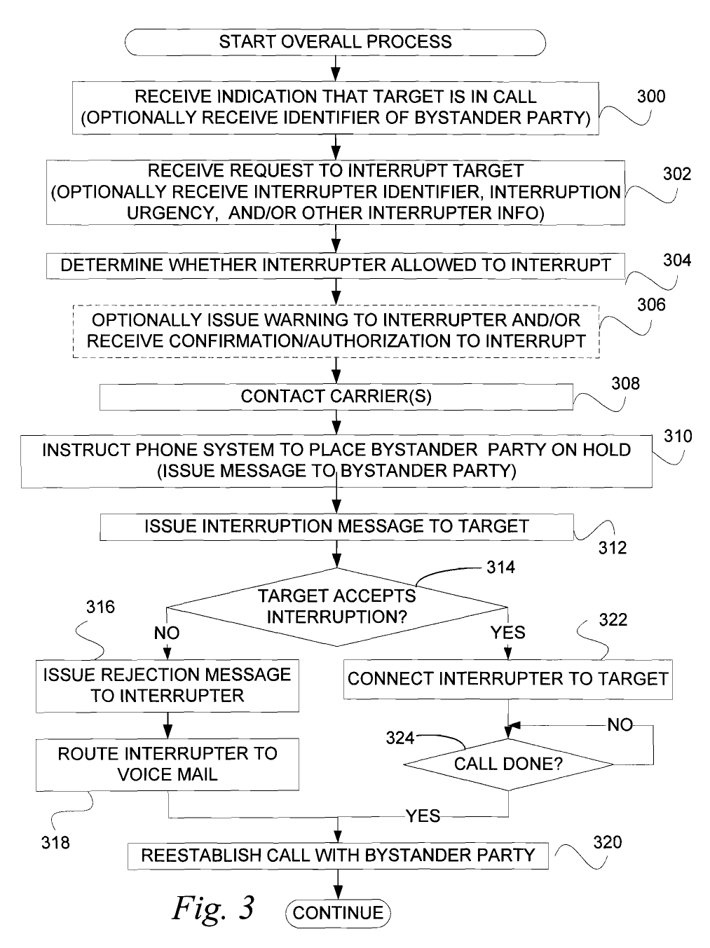

FIG. 3 is a flow diagram illustrating example logic for enabling a caller to interrupt a call. The following example is described in terms of logic performed by a call manager that may be partially or completely located at a central network node and/or at a target device. An operation 300, the call manager receives an indication that a target party is currently participating in a call using a target device. The call manager may also optionally receive an identifier of a bystander party and/or corresponding bystander party device with which the target party is currently communicating.

The call manager receives a request to interrupt the target party, at operation 302. The request, or a subsequent message, may include an identifier, location, carrier identifier, and/or other information regarding the interrupter. The request, or a subsequent message may also indicate an urgency, a priority, a reason, and/or other information about the proposed interruption. In one embodiment, the interrupter may set, or submit a request to override one or more settings on the target device. For instance, the interrupter may request to override a ringer-off setting, or a vibrate-only setting on the target device. The interrupter or the call manager may provide information that would cause the target device to ring with a certain ring tone, at a certain volume level, and/or other with another characteristic for an interruption call.

At an operation 304, the call manager determines whether the interrupter is allowed to interrupt. The determination may be based on preferences set by the target device user, by a system administrator, by a communication conditions determined by the call manager, and/or the like. For example, the target party may specify that interruptions are only allowed by certain interrupters, such as family members. The target party may also specify limitations based on a time of day, a location of the target device, a location of the interrupter, a potential cost associated with an interruption, and/or other criteria. Similarly, the call manager may determine limitations based on the signal strength from the interrupter, a probability that the interrupter is attempting to deliver unsolicited information, past behaviors of the target party, and/or the like. Conversely, the determination may be based solely on the fact that the interrupter submitted the request. In that case, the interrupter has the sole control over interrupting an active call.

At an optional operation 306, the call manager may issue a warning message to the interrupter. The warning may be a standardized or custom message indicating that an interruption should be made only in emergency situations and/or under conditions explained in the message. The call manager may also optionally instruct the interrupter to submit authorization information and/or otherwise confirm that the interruption should be made. For instance, the call manager may require that the interrupter enter a special interruption code. The call manager may interface with an authorization service to authenticate the interrupter. The call manager may also require that the interrupter agree to accept a charge for the interruption. The charge may be set by the call manager, the carrier(s), and/or the target party. In addition, or alternatively, the call manager may provide an advertisement to the interrupter.

In this example embodiment, if it is determined that the interruption should be allowed, the call manager contacts the target device's communication network at an operation 308. For example, a central call manager may contact the target device's cellular telephone carrier to obtain access to the target device's current call. The call manager may also need to contact the same or a different carrier for the bystander party device that is currently communicating with the target device. At an operation in 310, the call manager instructs the target's and/or bystander party's carrier to place the bystander party on hold. In another embodiment, the target device may place the bystander party on hold or issue instructs the target's and/or bystander party's carrier to place the bystander party on hold. The call manager and/or the carrier may issue a message to the bystander party device, explaining that the bystander party has been placed on hold while an interruption request is processed. In another embodiment, the call manger may simply terminate the currently active call with the bystander party device. In yet another embodiment, the call manger may initiate a joining of the currently active call, such as automatically initiating a conference call without pre-planning the conference call or without placing the bystander party device on hold before initiating the conference call.

Similarly, at an operation 312, the call manager issues and interruption message to the target device, explaining that an interrupting party is attempting to interrupt. In one embodiment, the interruption message may be a voice message. In another embodiment, the interruption message may be a text message, and/or other message. The content of the message may identify the interrupter, an urgency of the interruption, a priority level of the interruption, and/or other interruption information. Embodiments may also allow the bystander party to remain connected to the call during a portion, or all of the interruption. For example, the bystander party may stay connected until the target party accepts the interruption.

At a decision operation 314, the call manager may wait for an indication from the target device on whether the target party will accept the interruption. In one embodiment, the call manager instructs the target device's carrier to issue a voice request that the target party press a certain button. The carrier may interpret the button press, or lack of button press, and relay a message to the call manager. In another embodiment, the call manager may issue an SMS message through the target to client's carrier to the target device, and wait for a return SMS message. If the target party does not accept the interruption request, the call manager issues a rejection message to the interrupter, at an operation 316. The call manager may also route the interrupter to the target device's voicemail system, at an operation 318. At an operation 320, the call manager instructs the carrier(s) to reestablish the call between the client device and the bystander party device.

If the target party accepts the interruption request, the call manager issues in instruction to the carrier (as) to connect the interrupter with the target device, at an operation 322. At a decision operation 324, the call manager waits for in indication that the interruption call is completed. The call manager then reestablishes the call between the target device and the bystander party device, at operation 320.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A method for interrupting a call, comprising:
receiving from an interrupter an interruption request to interrupt a currently active call between a target device and a bystander party device;
determining whether an interruption of the currently active call is allowed; and
automatically connecting the interrupter to the target device, if it is determined that the interruption is allowed.

2. The method of claim 1, wherein the interruption request includes interruption information and wherein the step of determining is based on the interruption information.

3. The method of claim 2, wherein the interruption information comprises at least one of the following: an identifier of the interrupter, a location of the interrupter, an urgency, and a reason for the interruption.

4. The method of claim 2, wherein the step of determining is based at least in part on comparing the interruption information with a criterion predefined by a target party associated with the target device.

5. The method of claim 1, wherein the step of determining comprises:
providing to the target device an indication of urgency of the interruption request; and
receiving from the target device an indication of whether to accept the interruption.

6. The method of claim 1, further comprising overriding a setting on the target device to cause the target device to indicate the interruption request.

7. The method of claim 1, further comprising receiving at least one of the following from the target device:
a confirmation to proceed with interrupting the currently active call; and
authorization information to proceed with interrupting the currently active call.

8. The method of claim 1, further comprising issuing a message to the bystander party device regarding the interruption request.

9. The method of claim 1, further comprising at least one of the following:
automatically placing the bystander party device on hold prior to automatically connecting the interrupter to the target device, if it is determined that the interruption is allowed; and
issuing an instruction to a network carrier to place the bystander party device on hold prior to automatically connecting the interrupter to the target device, if it is determined that the interruption is allowed.

10. The method of claim 1, further comprising at least one of the following:
issuing a rejection message to the interrupter, if it is determined that the interruption is not allowed; and
routing the interrupter to a voice mail system, if it is determined that the interruption is not allowed.

11. The method of claim 1, wherein the currently active call comprises a voice over internet protocol (VOIP) call.

12. A computer readable medium, comprising executable instructions for performing actions, including the actions of claim 1.

13. An apparatus for interrupting a voice communication, comprising:
a processor;
a communication interface in communication with
the processor,
an interrupter;
a target device; and
a bystander party device; and
a memory in communication with the processor and storing machine instructions that cause the processor to perform a plurality of operations, including:
receiving from an interrupter an interruption request to interrupt a currently active call between the target device and the bystander party device;
determining whether an interruption of the currently active call is allowed; and
automatically connecting the interrupter to the target device, if it is determined that the interruption is allowed.

14. The apparatus of claim 13, wherein the instructions further cause the processor to perform at least one of the following operations:
obtaining an agreement from the interrupter to accept a charge for interruption;
sending an advertisement to the interrupter.

15. The apparatus of claim 13, wherein the communication interface is in communication with a network carrier and wherein the machine instructions further cause the network carrier to perform at least one of the following operations:
receive from the network carrier the interruption request from the interrupter; and
issue an instruction to the network carrier to connect the interrupter to the target device, if it is determined that the interruption is allowed.

16. The apparatus of claim 13, wherein at least one of the following is a mobile device; the apparatus, the interrupter, the target device, and the bystander party device.

17. The apparatus of claim 13, wherein the interruption comprises one of the following:
a pause in the currently active call;
a termination of the currently active call; and
a joining of the currently active call.

18. The apparatus of claim 13, wherein the step of determining is based solely on receiving the interruption request from the interrupter.

19. A target device comprising:
a processor;
a communication interface in communication with
the processor,
an interrupter; and
a bystander party device; and
a memory in communication with the processor and storing machine instructions that cause the processor to perform a plurality of operations, including:
receiving from the interrupter an interruption request to interrupt a currently active call between the target device and the bystander party device;
determining whether an interruption of the currently active call is allowed; and
automatically connecting to the interrupter, if it is determined that the interruption is allowed.

20. The target device of claim 19, wherein the instructions causes the processor to further perform one of the following operations:
issuing an instruction to place the bystander party device on hold;
issuing an instruction to initiate a joining of the currently active call by the interrupter; and
terminating the currently active call.
